(19) United States
(12) Patent Application Publication
(10) Pub. No.: US 2026/0254044 A1
(43) Pub. Date: Aug. 27, 2026

(54) ADAPTIVE VENT PATH MANAGEMENT STRATEGIES FOR TRACTION BATTERY PACKS

(71) Applicant: FORD GLOBAL TECHNOLOGIES, LLC, Dearborn, MI (US)

(72) Inventors: Di Zhu, Novi, MI (US); Liwen Zhang, Novi, MI (US); Bhaskara Rao Boddakayala, Troy, MI (US)

(21) Appl. No.: 19/059,720

(22) Filed: Feb. 21, 2025

(51) Int. Cl. H01M 50/375; B60L 50/64; H01M 50/204; H01M 50/249; H01M 50/296; H01M 50/325

(52) U.S. Cl. CPC H01M 50/375; B60L 50/64; H01M 50/204; H01M 50/249; H01M 50/296; H01M 50/325; H01M 2200/10; H01M 2220/20

(57) ABSTRACT

Adaptive vent path management strategies are provided for traction battery packs. The traction battery pack may include a sacrificial component that can transition from a non-deformed state to a deformed state to provide an adaptive vent flow path within the traction battery pack. For example, the sacrificial component may be designed to plastically deform (e.g., melt, sag, etc.) to block a primary vent flow path and thereby redirect battery vent byproducts to a secondary vent flow path during a battery thermal event. The sacrificial component may incorporate a combination of different materials for achieving the adaptive vent flow path.

### TECHNICAL FIELD

This disclosure relates generally to traction battery packs, and more particularly to adaptive vent path management concepts that involve blocking and redirecting battery vent byproducts during a battery thermal event of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery array, and a sacrificial component configured to transition from a non-deformed state to a deformed state to establish an adaptive vent flow path inside the traction battery pack during a battery thermal event.

In a further non-limiting embodiment of the foregoing traction battery pack, the sacrificial component is a low voltage connector.

In a further non-limiting embodiment of either of the foregoing traction battery packs, the sacrificial component is a venting device.

In a further non-limiting embodiment of any of the foregoing traction battery packs, the sacrificial component is positioned near a first inboard end of the battery array.

In a further non-limiting embodiment of any of the foregoing traction battery packs, the first inboard end of the battery array faces toward a second inboard end of a second battery array.

In a further non-limiting embodiment of any of the foregoing traction battery packs, in the deformed state, the sacrificial component provides a barrier that blocks a primary vent flow path through the sacrificial component.

In a further non-limiting embodiment of any of the foregoing traction battery packs, the barrier is configured to redirect a battery vent byproduct released by a battery cell of the battery array toward a secondary vent flow path.

In a further non-limiting embodiment of any of the foregoing traction battery packs, the secondary vent flow path is provided by a venting device of the battery array.

In a further non-limiting embodiment of any of the foregoing traction battery packs, the venting device is a high voltage terminal of the battery array.

In a further non-limiting embodiment of any of the foregoing traction battery packs, the sacrificial component includes a first portion made of a first material and a second portion made of a second material that is different from the first material.

In a further non-limiting embodiment of any of the foregoing traction battery packs, the first material is a thermoset material, and the second material is a thermoplastic material.

In a further non-limiting embodiment of any of the foregoing traction battery packs, the first material is a metallic material, and the second material is a thermoplastic material.

In a further non-limiting embodiment of any of the foregoing traction battery packs, the first portion is a top surface of the sacrificial component, and the second portion is a side surface of the sacrificial component.

In a further non-limiting embodiment of any of the foregoing traction battery packs, the first portion is a shell of the sacrificial component, and the second portion is a body of the sacrificial component.

A traction battery pack according to another exemplary aspect of the present disclosure includes, among other things, a first battery array, a second battery array adjacent to the first battery array, and a sacrificial component configured to plastically deform to block and then redirect a flow of a battery vent byproduct away from the second battery array when a battery cell of the first battery array experiences a battery thermal event.

In a further non-limiting embodiment of the foregoing traction battery pack, the sacrificial component is a low voltage connector of the first battery array.

In a further non-limiting embodiment of either of the foregoing traction battery packs, the sacrificial component includes a top surface, a bottom surface, and a first side surface, a second side surface, and a third side surface that connect between the top surface and the bottom surface.

In a further non-limiting embodiment of any of the foregoing traction battery packs, the top surface is made of a thermoset material, and the first side surface, the second side surface, and the third side surface are made of a thermoplastic material.

In a further non-limiting embodiment of any of the foregoing traction battery packs, the sacrificial component includes a body and a shell that covers at least three surfaces of the body.

In a further non-limiting embodiment of any of the foregoing traction battery packs, the body is made of a thermoplastic material, and the shell is made of a metallic material or a thermoset material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a highly schematically top view of a traction battery pack of an electrified vehicle.

FIG. 3 schematically illustrates a first stage of a battery thermal event occurring within a battery array of a traction battery pack.

FIG. 4 schematically illustrates a second stage of the battery thermal event.

FIG. 5 illustrates an exemplary sacrificial component of a battery array of a traction battery pack.

FIG. 6 illustrates another exemplary sacrificial component of a battery array of a traction battery pack.

### DETAILED DESCRIPTION

This disclosure details adaptive vent path management strategies for traction battery packs. The traction battery pack may include a sacrificial component that can transition from a non-deformed state to a deformed state to provide an adaptive vent flow path within the traction battery pack. For example, the sacrificial component may be designed to plastically deform (e.g., melt, sag, etc.) to block a primary vent flow path and thereby redirect battery vent byproducts to a secondary vent flow path during a battery thermal event. The sacrificial component may incorporate a combination of different materials for achieving the adaptive vent flow path. These and other features are discussed in greater detail in the following paragraphs of this detailed description.

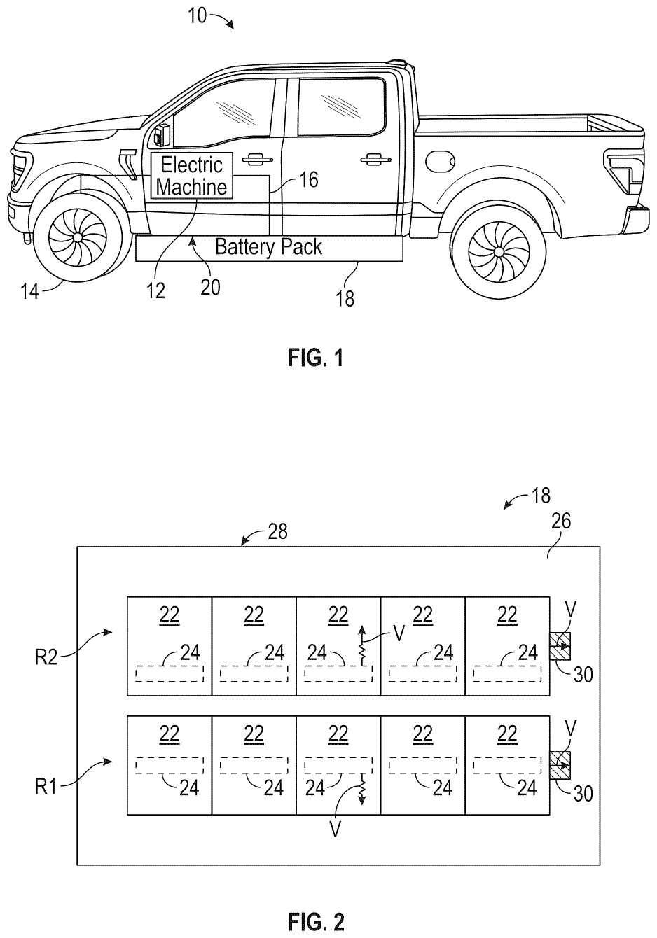

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

FIG. 2 schematically illustrates additional details associated with the traction battery pack 18 of the electrified vehicle 10 of FIG. 1. The traction battery pack 18 may include a plurality of battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

Each battery array 22 of the traction battery pack 18 may include one or more battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 2.

In an embodiment, the battery cells 24 are lithium-ion pouch or prismatic cells. However, battery cells having other geometries and/or chemistries (nickel-metal hydride, lead-acid, etc.) could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. Although shown schematically, the enclosure assembly 28 may include a sealed two-piece enclosure design that includes an enclosure cover that is securable (e.g., bolted, welded, adhered, etc.) to an enclosure tray to provide the interior area 26 for housing the battery arrays 22 and other battery internal components of the traction battery pack 18.

The battery cells 24 of each battery array 22 may be stacked together and arranged along a stack axis. The total number of battery cells 24 included within each battery array 22 can vary and is therefore not intended to limit this disclosure.

The battery arrays 22 of the traction battery pack 18 may be arranged together within the interior area 26 in multiple laterally adjacent rows. In the exemplary embodiment, the traction battery pack 18 includes a first row R1 of five battery arrays 22 and a second row R2 of five additional battery arrays 22 for a total of ten battery arrays 22. However, the traction battery pack 18 could include a greater or fewer number of battery arrays and still fall within the scope of this disclosure.

From time to time, pressure and thermal energy within at least one of the battery cells 24 of one of the battery arrays 22 can increase. This can lead to a battery thermal event in which the effected battery cell 24 discharges a flow of battery vent byproducts V, which can include both gas and debris. The battery vent byproducts V can be discharged from the battery cell 24 through a designated cell vent within a housing of the battery cell 24. The cell vent can be a membrane that yields in response to increased pressure and thermal energy within the battery cell 24 or could alternatively be a ruptured area of the effected battery cell 24. Vent ducts 30 may be positioned relative to each row R1, R2 of the battery arrays 22 for providing a path for purging the battery vent byproducts V from the traction battery pack 18 during the battery thermal event.

In some instances, thermal energy associated with the battery vent byproducts V could move to adjacent battery cells 24 and/or battery arrays 22 that are not venting. The flow of battery vent byproducts V to battery cells 24 that are not venting could, in some instances, raise a temperature of those battery cells 24 and cause them to release their own battery vent byproducts V and thereby cause the battery thermal event to cascade through the remaining battery cells 24 and battery arrays 22 of the traction battery pack 18. This disclosure is therefore directed to unique vent path management strategies that can substantially contain the thermal energy associated with the battery vent byproducts V to a single battery array 22, thereby preventing the battery thermal event from propagating across the entire traction battery pack 18.

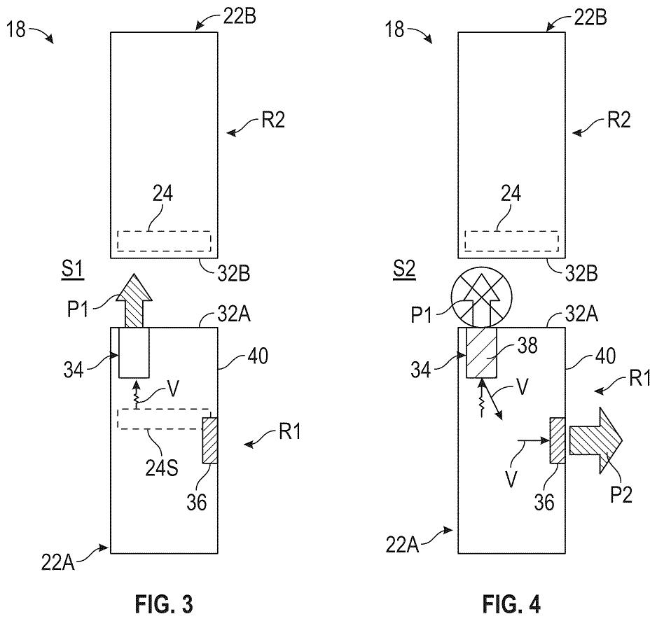

FIGS. 3 and 4 illustrate select portions of the traction battery pack 18 of FIGS. 1-2. A first battery array 22A of the first row R1 and a second battery array 22B of the second row R2 of the traction battery pack 18 are specifically illustrated. The first battery array 22A may include a first inboard end 32A, and the second battery array 22B may include a second inboard end 32B. The first battery array 22A may be arranged relative to the second battery array 22B such that the first inboard end 32A faces toward the second inboard end 32B.

FIG. 3 schematically illustrates a first stage S1 of a battery thermal event that can originate from within the first battery array 22A, and FIG. 4 schematically illustrates a second stage S2 of the battery thermal event. The first stage S1 may occur near the beginning of the battery thermal event, and the second stage S2 may occur at a point in time after the first stage S1.

The first stage S1 of the battery thermal event may begin when a trigger battery cell 24S of the first battery array 22A releases the battery vent byproducts V. The first battery array 22A is therefore considered the “trigger” array of the traction battery pack 18 in this exemplary embodiment. However, a person of ordinary skill in the art would understand that any of the battery arrays 22 of the traction battery pack 18 could act as the “trigger” array depending on the operating environment and various other considerations.

The first battery array 22A may include a sacrificial component 34. The sacrificial component 34 may be positioned near the first inboard end 32A of the first battery array 22A. However, other locations are also possible within the scope of this disclosure. Although shown only with respect to the first battery array 22A in the exemplary embodiments, a person of ordinary skill in the art would understand that each battery array 22 of the traction battery pack 18 could be quipped with a similarly situated and configured sacrificial component for providing the adaptive vent management strategies described herein.

In an embodiment, the sacrificial component 34 is a low voltage connector of the first battery array 22A. In another embodiment, the sacrificial component 34 is a venting device of the first battery array 22A. However, other components could be utilized as the sacrificial component 34 within the scope of this disclosure.

The sacrificial component 34 may provide a path of least resistance against the flow of battery vent byproducts V during the first stage S1 of the battery thermal event. Therefore, a majority of the battery vent byproducts V released by the trigger battery cell 24S of the first battery array 22A can pass through a primary vent flow path P1 provided by the sacrificial component 34 during the first stage S1 of the battery thermal event.

The sacrificial component 34 may transition from a first or non-deformed state to a second or deformed state as the battery thermal event progresses from the first stage S1 to the second stage S2 in order to provide an adaptive vent management path. In an embodiment, the sacrificial component 34 transitions from the first state to the second state by plastically deforming. For example, the sacrificial component 34 may be designed to plastically deform, such as by melting, sagging, or otherwise deforming, during the battery thermal event. The second stage S2 of the battery thermal event may begin when the sacrificial component plastically deforms and thereby forms a barrier 38 that closes off or blocks the primary vent flow path P1. The barrier 38 is schematically illustrated in FIG. 4.

Due to the barrier 38 established by plastically deforming at least a portion of the sacrificial component 34, the battery vent byproducts V may be redirected in a direction away from the first inboard end 32A and toward a venting device 36 of the first battery array 22A. The venting device 36 may be positioned near a longitudinal side 40 of the first battery array 22A. The longitudinal side 40 extends along an axis that is transverse to the axis along which the first inboard end 32A extends.

In an embodiment, the venting device 36 is a high voltage terminal of the first battery array 22A. However, other components could be utilized as the venting device 36 within the scope of this disclosure.

After being redirected in the manner described above, the battery vent byproducts V may flow through a secondary vent flow path P2 provided by the venting device 36. Accordingly, a majority of the convection associated with the battery vent byproducts V is directed away from the second battery array 22B, thus preventing the second battery array 22B from going into a thermal event. Blocking and redirecting the battery vent byproducts V released by the trigger battery cell 24S of the first battery array 22A in this manner can substantially prevent the battery thermal event from cascading throughout the traction battery pack 18.

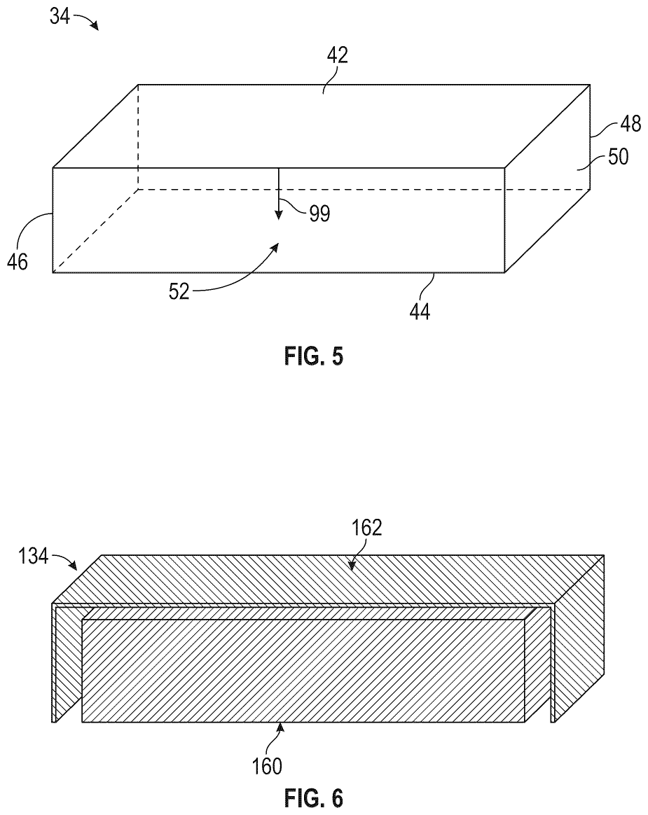

FIG. 5, with continued reference to FIGS. 3-4, illustrates an exemplary sacrificial component 34 that could be employed for use within the traction battery pack 18 in order to provide the adaptive vent path management strategy described above. The sacrificial component 34 may include a box-like structure that includes a top surface 42, a bottom surface 44, a first side surface 46, a second side surface 48, a third side surface 50, and an open side 52.

The top surface 42 may be made of a first material that is different from a second material of the first side surface 46, the second side surface 48, and the third side surface 50. For example, the first material may have a first melting temperature that is greater than a second melting temperature of the second material. During the battery thermal event, the first side surface 46, the second side surface 48, and the third side surface 50 can plastically deform by melting, thereby causing the top surface 42, which generally does not deform when exposed to the increased temperatures brought on by the battery vent byproducts V, to drop or otherwise move in a direction 99 against the bottom surface 44 and establish the barrier 38 for blocking the primary vent flow path P1.

In an embodiment, the top surface 42 is made of a thermoset material, and the first side surface 46, the second side surface 48, and the third side surface 50 are made of a thermoplastic material. Exemplary thermoset materials include but are not limited to ethylene propylene diene monomer (EPDM), silicone rubber, ceramic rubber, phenol formaldehyde, etc., and exemplary thermoplastic materials include but are not limited to polyurethane, polypropylene, polybutylene terephthalate, etc. However, other materials or combinations of materials could be utilized within the scope of this disclosure.

FIG. 6, with continued reference to FIGS. 3-4, illustrates another exemplary sacrificial component 134 that could be employed for use within the traction battery pack 18 in order to provide the adaptive vent path management strategy described above. The sacrificial component 134 may include a body 160 that is at least partially surrounded by a shell 162. In an embodiment, the shell 162 is arranged to cover three or four side surfaces of the body 160.

The shell 162 may be made of a first material that is different from a second material of the body 160. For example, the first material may have a first melting temperature that is greater than a second melting temperature of the second material. During the battery thermal event, the body 160 can plastically deform by melting. As the body 160 melts, the shell 162, which generally does not deform when exposed to the increased temperatures associated with the battery vent byproducts V, may direct where the melted material of the body 160 flows and/or trap the melted material of the body 160 to establish the barrier 38 for blocking the primary vent flow path P1.

In an embodiment, the shell 162 is made of a metallic material or a thermoset material, and the body 160 is made of a thermoplastic material. However, other materials or combinations of materials could be utilized within the scope of this disclosure.

The traction battery packs of this disclosure may incorporate sacrificial components that can transition between non-deformed states and deformed states in order to provide an adaptive vent flow path during a battery thermal event. The adaptive vent flow path enables battery vent byproducts to be redirected during the battery thermal event, thereby substantially preventing thermal energy from propagating through the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array; and
a sacrificial component configured to transition from a non-deformed state to a deformed state to establish an adaptive vent flow path inside the traction battery pack during a battery thermal event.

2. The traction battery pack as recited in claim 1, wherein the sacrificial component is a low voltage connector.

3. The traction battery pack as recited in claim 1, wherein the sacrificial component is a venting device.

4. The traction battery pack as recited in claim 1, wherein the sacrificial component is positioned near a first inboard end of the battery array.

5. The traction battery pack as recited in claim 4, wherein the first inboard end of the battery array faces toward a second inboard end of a second battery array.

6. The traction battery pack as recited in claim 1, wherein, in the deformed state, the sacrificial component provides a barrier that blocks a primary vent flow path through the sacrificial component.

7. The traction battery pack as recited in claim 6, wherein the barrier is configured to redirect a battery vent byproduct released by a battery cell of the battery array toward a secondary vent flow path.

8. The traction battery pack as recited in claim 7, wherein the secondary vent flow path is provided by a venting device of the battery array.

9. The traction battery pack as recited in claim 8, wherein the venting device is a high voltage terminal of the battery array.

10. The traction battery pack as recited in claim 1, wherein the sacrificial component includes a first portion made of a first material and a second portion made of a second material that is different from the first material.

11. The traction battery pack as recited in claim 10, wherein the first material is a thermoset material and the second material is a thermoplastic material.

12. The traction battery pack as recited in claim 10, wherein the first material is a metallic material and the second material is a thermoplastic material.

13. The traction battery pack as recited in claim 10, wherein the first portion is a top surface of the sacrificial component and the second portion is a side surface of the sacrificial component.

14. The traction battery pack as recited in claim 10, wherein the first portion is a shell of the sacrificial component and the second portion is a body of the sacrificial component.

15. A traction battery pack, comprising:
a first battery array;
a second battery array adjacent to the first battery array; and
a sacrificial component configured to plastically deform to block and then redirect a flow of a battery vent byproduct away from the second battery array when a battery cell of the first battery array experiences a battery thermal event.

16. The traction battery pack as recited in claim 15, wherein the sacrificial component is a low voltage connector of the first battery array.

17. The traction battery pack as recited in claim 15, wherein the sacrificial component includes a top surface, a bottom surface, and a first side surface, a second side surface, and a third side surface that connect between the top surface and the bottom surface.

18. The traction battery pack as recited in claim 17, wherein the top surface is made of a thermoset material, and the first side surface, the second side surface, and the third side surface are made of a thermoplastic material.

19. The traction battery pack as recited in claim 15, wherein the sacrificial component includes a body and a shell that covers at least three surfaces of the body.

20. The traction battery pack as recited in claim 19, wherein the body is made of a thermoplastic material, and the shell is made of a metallic material or a thermoset material.
